(19) United States
(12) Patent Application Publication
(10) Pub. No.: US 2016/0050129 A1
(43) Pub. Date: Feb. 18, 2016

(54) PERFORMANCE ASSESSMENT BASED ON ANALYSIS OF RESOURCES

(71) Applicant: Google Inc., Mountain View, CA (US)

(72) Inventor: Neil Hoyne, Santa Clara, CA (US)

(21) Appl. No.: 14/461,236

(22) Filed: Aug. 15, 2014

(51) Int. Cl. H04L 12/26; G06F 17/30

(52) U.S. Cl. CPC H04L 43/08; G06F 17/30861

(57) ABSTRACT

Systems, methods, and computer-readable storage media that may be used to evaluate performance of resources and/or content campaign impressions are provided. One method includes, for each of a first set of resources: (1) filtering path data to extract a first set of path data items including an interaction with the resource and a second set of path data items including paths excluding an interaction with the resource; (2) calculating first and second conversion metrics based on an amount of the first and second sets of path data items, respectively, resulting in a conversion action; and (3) calculating an incremental conversion metric for the resource based on the first conversion metric and the second conversion metric. The method further includes generating resource comparison data comparing one or more of the first set of resources based on the incremental conversion metrics.

### BACKGROUND

Content providers often publish content items in networked resources through online content management systems with the goal of having an end user interact with (e.g., click through) the content items and perform a converting action, such as providing information of value to the content providers and/or purchasing a product or service offered by the content providers. The quality of content item impressions and/or placements published within resources can have a substantial impact in driving incremental conversions. In some cases, the quality of the impressions may have a more substantial impact than clicks in driving conversions.

### SUMMARY

One illustrative implementation of the disclosure relates to a method that includes receiving, by one or more processors, path data including a plurality of path data items representing a plurality of paths, each path including one or more interactions of a user with content items published within one or more of a plurality of resources. The method further includes, for each resource of a first set of the plurality of resources: (1) filtering, by the one or more processors, the path data to extract a first set of path data items including an interaction with the resource and a second set of path data items, the first and second sets of path data items each including paths relating to two or more of the content providers, and the second set of path data items including paths that exclude an interaction with the resource; (2) calculating, by the one or more processors, a first conversion metric based on an amount of the first set of path data items including the interaction with the resource resulting in one of a plurality of conversion actions reflected in the path data; (3) calculating, by the one or more processors, a second conversion metric based on an amount of the second set of path data items excluding the interaction with the resource resulting in one of the conversion actions; and (4) calculating, by the one or more processors, an incremental conversion metric for the resource based on the first conversion metric and the second conversion metric, the incremental conversion metric relating to a contribution of the interactions with the resource in causing the conversion actions across the paths relating to the two or more content providers. The method further includes generating resource comparison data comparing one or more of the first set of resources based on the incremental conversion metrics for the one or more resources.

Another implementation relates to a system including at least one computing device operably coupled to at least one memory. The at least one computing device is configured to receive path data including a plurality of path data items representing a plurality of paths, each path including one or more interactions of a user with content items published within one or more of a plurality of resources. The at least one computing device is further configured to, for each resource of a first set of the plurality of resources: (1) filter the path data to extract a first set of path data items including an interaction with the resource and a second set of path data items, the first and second sets of path data items each including paths relating to two or more of the content providers, and the second set of path data items including paths that exclude an interaction with the resource; (2) calculate a first conversion metric based on an amount of the first set of path data items including the interaction with the resource resulting in one of a plurality of conversion actions reflected in the path data; (3) calculate a second conversion metric based on an amount of the second set of path data items excluding the interaction with the resource resulting in one of the conversion actions; and (4) calculate an incremental conversion metric for the resource based on the first conversion metric and the second conversion metric, the incremental conversion metric relating to a contribution of the interactions with the resource in causing the conversion actions across the paths relating to the two or more content providers. The at least one computing device is further configured to generate resource comparison data comparing one or more of the first set of resources based on the incremental conversion metrics for the one or more resources.

Yet another implementation relates to one or more computer-readable storage media having instructions stored thereon that, when executed by at least one processor, cause the at least one processor to perform operations. The operations include receiving path data including a plurality of path data items representing a plurality of paths, each path including one or more interactions of a user with content items published within one or more of a plurality of resources. The operations further include, for each resource of a first set of the plurality of resources: (1) filtering the path data to extract a first set of path data items including an interaction with the resource and a second set of path data items, the first and second sets of path data items each including paths relating to two or more of the content providers, and the second set of path data items including paths that exclude an interaction with the resource; (2) calculating a first conversion metric based on an amount of the first set of path data items including the interaction with the resource resulting in one of a plurality of conversion actions reflected in the path data; (3) calculating a second conversion metric based on an amount of the second set of path data items excluding the interaction with the resource resulting in one of the conversion actions; and (4) calculating an incremental conversion metric for the resource based on the first conversion metric and the second conversion metric, the incremental conversion metric relating to a contribution of the interactions with the resource in causing the conversion actions across the paths relating to the two or more content providers. The operations further include receiving one or more parameters for a content campaign and identifying a subset of the first set of resources fulfilling the parameters. The operations further include generating resource comparison data comparing the subset of resources based on the incremental conversion metrics for the subset of resources.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a block diagram of an analysis system and associated environment according to an illustrative implementation.

FIG. 2 is a flow diagram of a process for comparing resources according to an illustrative implementation.

FIG. 3 is a flow diagram of a process for assessing performance of a content campaign according to an illustrative implementation.

FIG. 4 is a flow diagram of a process for comparing resources using multiple incremental conversion metrics associated with different conditions according to an illustrative implementation.

FIG. 5 is a flow diagram of another process for comparing resources using multiple incremental conversion metrics associated with different conditions according to an illustrative implementation.

FIG. 6 is an illustration of a user interface configured to provide resource recommendations according to an illustrative implementation.

FIG. 7 is an illustration of a user interface configured to provide an assessment of one or more content campaigns according to an illustrative implementation.

FIG. 8 is a block diagram of a detailed implementation of an analysis system according to an illustrative implementation.

FIG. 9 is a block diagram of a computing system according to an illustrative implementation.

### DETAILED DESCRIPTION

Referring generally to the Figures, various illustrative systems and methods are provided that may be used to compare conversion performance for multiple resources in which content items can be published. Defining impression quality can be difficult. In various implementations, content networks may define quality based on position within a resource (e.g., position on a webpage), quantity of competing content items from other content providers, strength of the competing content, viewable time of one or more parts of the resource, whether a user has hovered over the content item with a mouse, and/or other types of factors. However, it is difficult to determine what correlation each of the factors actually has to driving conversions, as compared to other factors. The ability to establish and continuously validate content impressions at the resource and/or placement level introduces significant inefficiencies in content purchasing. Additionally, by presenting individual metrics upon which placements are evaluated, publishers (e.g., resource publishers, such as publishers of websites or groups of websites) have an incentive to build towards those metrics, regardless of whether those metrics do, in fact, create more value for the content provider.

In some implementations, instead of trying to assign arbitrary, technical metrics to assess impression quality, attribution models may be utilized to calculate quality based on actual performance. Some attribution models may look at impressions at a granular level (e.g., placement, creative, number of impressions viewed, order, etc.) and derive/estimate the incrementality that each interaction contributed towards the end conversion (e.g., the role the interaction played in driving the conversion). This may help estimate a return on investment (ROI) for the campaign. While the ROI may suggest the content provider's total success in the campaign, it may not reveal the underlying variables that could be used to determine the actual quality of the impressions. For example, the content provider could have selected a poor creative for the audience of the resource, a frequency limit that led to wasted interactions, or built remarketing lists that were competing with the content provider's primary campaign. There may also be a limited sample size upon which inferences can be drawn. Performance may be driven positively by a lack of competing inventory and/or optimizations to win the favor of the client, or negatively with poor inventory management or changing resource designs. Attribution models often may capture only the aggregate effect. Attribution models may also be limited in providing a content provider with visibility into other placements into which the content provider should expand. As such, content providers may be limited to testing each resource individually to estimate an ROI for themselves.

According to various implementations, the systems and methods of the present disclosure may provide a better indication of impression and/or placement quality by comparing resource and/or content campaign performance based on aggregated data (e.g., data across multiple content providers and/or conditions). An analysis system may receive path data including path data items representing paths. Each path may include one or more interactions of a user with content items published within resources (e.g., webpages). For each of a first set of resources, the system may filter the path data to extract a first set of path data items including an interaction with the resource and a second set of path data items including paths that do not include an interaction with the resource. The system may calculate one conversion metric (e.g., conversion rate) for the paths that include an interaction with the resource and another conversion metric for the paths that do not include an interaction with the resource. The system may then calculate an incremental conversion metric based on these conversion metrics. The incremental conversion metric may be related to (e.g., used to infer) a contribution of the interactions with the resource in causing the conversions. For instance, in some implementations, a high incremental conversion metric may indicate a resource that contributes significantly to driving conversions, while a low incremental conversion metric may indicate a resource that does not contribute significantly to driving conversions, or perhaps even drives users away from conversion. The incremental conversion metrics for the resources may be used to generate resource comparison data used to compare the resources to one another. When done at the aggregate level across a large number of content providers, the system may develop a normalized condition for content serving that reduces impact of other variables on conversion, and may use attribution to calculate the quality of resource/site placements relative to one another, allowing content providers to choose the resource placements that may lead to the best incremental performance for their business. Such a system may provide a content provider with greater insight regarding the performance of resources without testing the resources manually.

In some implementations, the resource comparison data may be used to evaluate resources that are likely to drive conversions for particular campaigns. In some such implementations, parameters for a content campaign may be received (e.g., timing of the campaign, vertical, creative size, etc.), and a set of resources that fulfill the parameters may be identified. The system may generate resource comparison data to compare the identified resources based on the incremental conversion metrics of the resources. For instance, in some implementations, the system may generate a ranking of the available resources that meet the campaign parameters based on the incremental conversion metrics for the resources.

In some implementations, the system may evaluate the campaign based on the actual determined incrementality of the campaign in comparison to a predicted incrementality. The system may determine the resources in which content items from the campaign are to be displayed and calculate a predicted incremental conversion metric based on the incremental conversion metrics for the resources. The system may also calculate an actual incremental conversion metric based on path data pertaining to the content items from the campaign presented within the resources (e.g., based on conversion metrics for the paths including interactions with the campaign versus those not including interactions with the campaign). The system may compare the predicted and actual metrics to evaluate the campaign. For instance, the system may determine a difference between the predicted and actual metrics and generate a notification when the difference exceeds a threshold. In one illustrative implementation, when the actual metric is less than the predicted metric by more than the threshold, the system may recommend modifying one or more of the content items of the campaign (e.g., the content item creatives). In some implementations, the system may implement one or more bidding actions in response to the evaluation. For instance, if the actual metric is less than the predicted metric, the system may decrease a bid for presenting items within the a resource or a budget (e.g., total maximum budget) associated with content presented within the resource. If the actual metric is greater than the predicted metric, the system may increase the bid and/or budget.

In some implementations, the system may be configured to account for conditions other than the quality of the impressions/placements that may affect the likelihood of conversion. In some such implementations, the path data items may be filtered to only include items having similar characteristics. In some implementations, for each resource, multiple incremental conversion metrics may be calculated, with each corresponding to a different set of conditions affecting likelihood of conversion. In some implementations, the system may select the incremental conversion metric(s) to be used in comparing the resources based on the parameters of the campaign (e.g., select the incremental conversion metrics associated with conditions most closely corresponding to the parameters). In some implementations, the system may generate a relative incremental conversion metric for each resource to be used in comparing the resources based on a combination of the incremental conversion metrics for the resource. Such a relative incremental conversion metric may be used to reduce an impact of the varying conditions on the calculated incremental metric and help isolate the comparison to the impact of the resources on the likelihood of conversion.

For situations in which the systems discussed herein collect and/or utilize personal information about users, or may make use of personal information, the users may be provided with an opportunity to control whether programs or features that may collect personal information (e.g., information about a user's social network, social actions or activities, a user's preferences, a user's current location, etc.), or to control whether and/or how to receive content from the content server that may be more relevant to the user. In addition, certain data may be anonymized in one or more ways before it is stored or used, so that personally identifiable information is removed when generating parameters (e.g., demographic parameters). For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server. Further, the individual user information itself is not surfaced to the content provider, so the content provider cannot discern the interactions associated with particular users.

For situations in which the systems discussed herein collect and/or utilize information pertaining to one or more particular content providers, the content providers may be provided with an opportunity to choose whether to participate or not participate in the program/features collecting and/or utilizing the information. In some implementations, the information may be anonymized in one or more ways before it is utilized, such that the identity of the content provider with which it is associated cannot be discerned from the anonymized information. Additionally, data from multiple content providers may be aggregated, and data presented to a content provider may be based on the aggregated data, rather than on individualized data. In some implementations, the system may include one or more filtering conditions to ensure that the aggregated data includes enough data samples from enough content providers to prevent against any individualized content provider data being obtained from the aggregated data. The system does not present individualized data for a content provider to any other content provider.

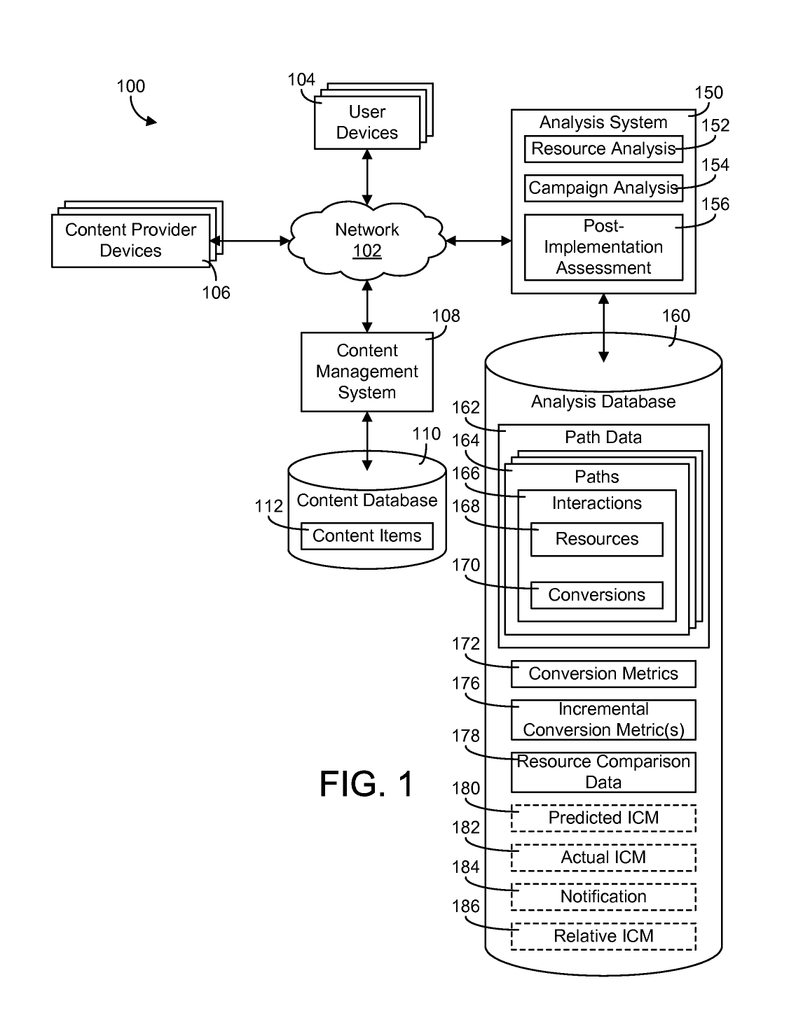

Referring now to FIG. 1, and in brief overview, a block diagram of an analysis system 150 and associated environment 100 is shown according to an illustrative implementation. One or more user devices 104 may be used by a user to perform various actions and/or access various types of content, some of which may be provided over a network 102 (e.g., the Internet, LAN, WAN, etc.). For example, user devices 104 may be used to access websites (e.g., using an internet browser), media files, and/or any other types of content. A content management system 108 may be configured to select content for display to users within resources (e.g., webpages, applications, etc.) and to provide content items 112 from a content database 110 to user devices 104 over network 102 for display within the resources. The content from which content management system 108 selects items may be provided by one or more content providers via network 102 using one or more content provider devices 106.

In some implementations, bids for content to be selected by content management system 108 may be provided to content management system 108 from content providers using devices, such as content provider devices 106, configured to communicate with content management system 108 through network 102. In such implementations, content management system 108 may determine content to be published in one or more content interfaces of resources (e.g., webpages, applications, etc.) shown on user devices 104 based at least in part on the bids. In some implementations, content management system 108 may determine the content to be published using an auction process.

An analysis system 150 may be configured to analyze path data relating to interactions of one or more users of user devices 104 and assess performance of one or more resources and/or content campaigns based on the path data. In some implementations, analysis system 150 may receive path data 162 that includes multiple paths 164. Each path 164 represents one or more interactions of a user with one or more resources (e.g., webpages, applications, etc.) and/or content items (e.g., paid and/or unpaid content items displayed within a resource, such as items displayed within a search engine results interface). For each of a set of one or more resources, system 150 may filter path data 162 to identify a first set of paths including interactions associated with the resources and a second set of paths including paths that do not include interactions associated with the resource. System 150 may calculate conversion metrics (e.g., conversion rates) for each set of paths based on the amount of paths in each set resulting in a conversion action (e.g., purchase of a product/service, provision of requested information from a user, etc.). System 150 may use the conversion metrics to calculate an incremental conversion metric for the resource. The incremental conversion metric may relate to, or be indicative of, a contribution of the interactions with the resource in causing the conversions. For instance, a high incremental conversion metric may indicate that the paths associated with the resource have a higher incidence of conversion than the paths not associated with the resource, and may imply that the resource has a substantial role in driving the conversions. A low incremental conversion metric may indicate that the paths associated with the resource have a lower incidence of conversion, and may imply that the resource does not have a substantial role in driving the conversions. In some instances, an incremental conversion metric indicating that the conversion metric associated with the resource is substantially lower than the conversion metric not associated with the resource may imply that the interactions with the resource are actually lowering a likelihood of users performing a conversion action. System 150 may utilize the incremental conversion metrics for the resources to compare two or more of the resources (e.g., to help a content provider decide the resources in which it wishes to publish its content campaigns). In some implementations, system 150 may calculate metrics 172 and/or 176 by using an attribution model configured to attribute conversions to one or more interactions prior to conversion (e.g., viewing of impressions, clicking on impressions, etc.).

Referring still to FIG. 1, and in greater detail, user devices 104 and/or content provider devices 106 may be any type of computing device (e.g., having a processor and memory or other type of computer-readable storage medium), such as a television and/or set-top box, mobile communication device (e.g., cellular telephone, smartphone, etc.), computer and/or media device (desktop computer, laptop or notebook computer, netbook computer, tablet device, gaming system, etc.), or any other type of computing device. In some implementations, one or more user devices 104 may be set-top boxes or other devices for use with a television set. In some implementations, content may be provided via a web-based application and/or an application resident on a user device 104. In some implementations, user devices 104 and/or content provider devices 106 may be designed to use various types of software and/or operating systems. In various illustrative implementations, user devices 104 and/or content provider devices 106 may be equipped with and/or associated with one or more user input devices (e.g., keyboard, mouse, remote control, touchscreen, etc.) and/or one or more display devices (e.g., television, monitor, CRT, plasma, LCD, LED, touchscreen, etc.).

User devices 104 and/or content provider devices 106 may be configured to receive data from various sources using a network 102. In some implementations, network 102 may comprise a computing network (e.g., LAN, WAN, Internet, etc.) to which user devices 104 and/or content provider device 106 may be connected via any type of network connection (e.g., wired, such as Ethernet, phone line, power line, etc., or wireless, such as WiFi, WiMAX, 3G, 4G, satellite, etc.). In some implementations, network 102 may include a media distribution network, such as cable (e.g., coaxial metal cable), satellite, fiber optic, etc., configured to distribute media programming and/or data content.

Content management system 108 may be configured to conduct a content auction among third-party content providers to determine which third-party content is to be provided to a user device 104. For example, content management system 108 may conduct a real-time content auction in response to a user device 104 requesting first-party content from a content source (e.g., a website, search engine provider, etc.) or executing a first-party application. Content management system 108 may use any number of factors to determine the winner of the auction. For example, the winner of a content auction may be based in part on the third-party content provider's bid and/or a quality score for the third-party provider's content (e.g., a measure of how likely the user of the user device 104 is to click on the content). In other words, the highest bidder is not necessarily the winner of a content auction conducted by content management system 108, in some implementations.

Content management system 108 may be configured to allow third-party content providers to create campaigns to control how and when the provider participates in content auctions. A campaign may include any number of bid-related parameters, such as a minimum bid amount, a maximum bid amount, a target bid amount, or one or more budget amounts (e.g., a daily budget, a weekly budget, a total budget, etc.). In some cases, a bid amount may correspond to the amount the third-party provider is willing to pay in exchange for their content being presented at user devices 104. In some implementations, the bid amount may be on a cost per impression or cost per thousand impressions (CPM) basis. In further implementations, a bid amount may correspond to a specified action being performed in response to the third-party content being presented at a user device 104. For example, a bid amount may be a monetary amount that the third-party content provider is willing to pay, should their content be clicked on at the client device, thereby redirecting the client device to the provider's webpage or another resource associated with the content provider. In other words, a bid amount may be a cost per click (CPC) bid amount. In another example, the bid amount may correspond to an action being performed on the third-party provider's website, such as the user of the user device 104 making a purchase. Such bids are typically referred to as being on a cost per acquisition (CPA) or cost per conversion basis.

A campaign created via content management system 108 may also include selection parameters that control when a bid is placed on behalf of a third-party content provider in a content auction. If the third-party content is to be presented in conjunction with search results from a search engine, for example, the selection parameters may include one or more sets of search keywords. For instance, the third-party content provider may only participate in content auctions in which a search query for “golf resorts in California” is sent to a search engine. Other illustrative parameters that control when a bid is placed on behalf of a third-party content provider may include, but are not limited to, a topic identified using a device identifier's history data (e.g., based on webpages visited by the device identifier), the topic of a webpage or other first-party content with which the third-party content is to be presented, a geographic location of the client device that will be presenting the content, or a geographic location specified as part of a search query. In some cases, a selection parameter may designate a specific webpage, website, or group of websites with which the third-party content is to be presented. For example, an advertiser selling golf equipment may specify that they wish to place an advertisement on the sports page of an particular online newspaper.

Content management system 108 may also be configured to suggest a bid amount to a third-party content provider when a campaign is created or modified. In some implementations, the suggested bid amount may be based on aggregate bid amounts from the third-party content provider's peers (e.g., other third-party content providers that use the same or similar selection parameters as part of their campaigns). For example, a third-party content provider that wishes to place an advertisement on the sports page of an online newspaper may be shown an average bid amount used by other advertisers on the same page. The suggested bid amount may facilitate the creation of bid amounts across different types of client devices, in some cases. In some implementations, the suggested bid amount may be sent to a third-party content provider as a suggested bid adjustment value. Such an adjustment value may be a suggested modification to an existing bid amount for one type of device, to enter a bid amount for another type of device as part of the same campaign. For example, content management system 108 may suggest that a third-party content provider increase or decrease their bid amount for desktop devices by a certain percentage, to create a bid amount for mobile devices.

Analysis system 150 may be configured to analyze path data 162 relating to user interactions with one or more items, such as resources (e.g., webpages, applications, etc.) and/or paid or unpaid content items displayed within an interface in a resource (e.g., a webpage content item interface), and assess performance of one or more resources and/or content campaigns. Analysis system 150 may include one or more processors (e.g., any general purpose or special purpose processor), and may include and/or be operably coupled to one or more memories (e.g., any computer-readable storage media, such as a magnetic storage, optical storage, flash storage, RAM, etc.). In various implementations, analysis system 150 and content management system 108 may be implemented as separate systems or integrated within a single system (e.g., content management system 108 may be configured to incorporate some or all of the functions/capabilities of analysis system 150).

Analysis system 150 may include one or more modules (e.g., implemented as computer-readable instructions executable by a processor) configured to perform various functions of analysis system 150. Analysis system 150 may include a resource analysis module 152 configured to analyze path data 162 and analyze performance of one or more resources 168. For each resource to be analyzed, module 152 may filter paths 164 into a first set of paths including interactions with the resource (e.g., interactions with content items presented within a content interface of the resource) and a second set of paths including paths that exclude interactions with the resource. Module 152 may calculate conversion metrics 172 for each set of paths. A first conversion metric (e.g., a first conversion rate) may be based on a number of the first set of paths associated with the resource resulting in a conversion 170, and a second conversion metric may be based on a number of the second set of paths not associated with the resource resulting in a conversion 170. Module 152 may use the first and second conversion metrics to generate an incremental conversion metric 176 for each resource. Incremental conversion metric 176 may relate to the contribution of the resource in driving conversions 170, and may provide an indication of how frequently paths including interactions with a resource resulted in conversion as compared to paths not including interactions with the resource. Module 152 may use incremental conversion metrics 176 to generate resource comparison data 178 comparing one or more of resources 168 to one another. In some implementations, module 152 may calculate multiple incremental conversion metrics for each resource, each associated with a different set of conditions affecting a likelihood of conversion, and may calculate a relative incremental conversion metric 186 based on the calculated incremental conversion metrics for the resource. This may help reduce an impact of factors other than the resource on the calculated conversion metric, such that relative incremental conversion metric 186 may more directly represent an effect of the resource on the likelihood of conversion.

In some implementations, analysis system 150 may include a campaign analysis module 154 configured to generate resource recommendations based on one or more parameters for a content campaign. Module 154 may determine a set of resources that fulfill the parameters of the campaign. Module 154 may generate or modify resource comparison data 178 to provide a comparison between the resources that fulfill the parameters.

In some implementations, analysis system 150 may include a post-implementation assessment module 156 configured to assess the performance of a content campaign. Module 156 may determine a set of resources in which content items of the campaign have been displayed, or are set to be displayed. Module 156 may calculate a predicted incremental conversion metric 180 for the campaign based on the incremental conversion metrics for the resources in which the content items of the campaign are displayed. Module 156 may also calculate an actual incremental conversion metric 182 for the campaign by analyzing path data associated with interactions with the content items of the campaign within the resources. Module 156 may compare predicted incremental conversion metric 180 and actual incremental conversion metric 182 and analyze the performance of the campaign based on the comparison (e.g., determine how the campaign performed with reference to the predicted performance). Based on the analysis, module 156 may generate one or more notifications 184 to the content provider associated with the campaign (e.g., recommendations that the content provider consider modifying the campaign to improve performance).

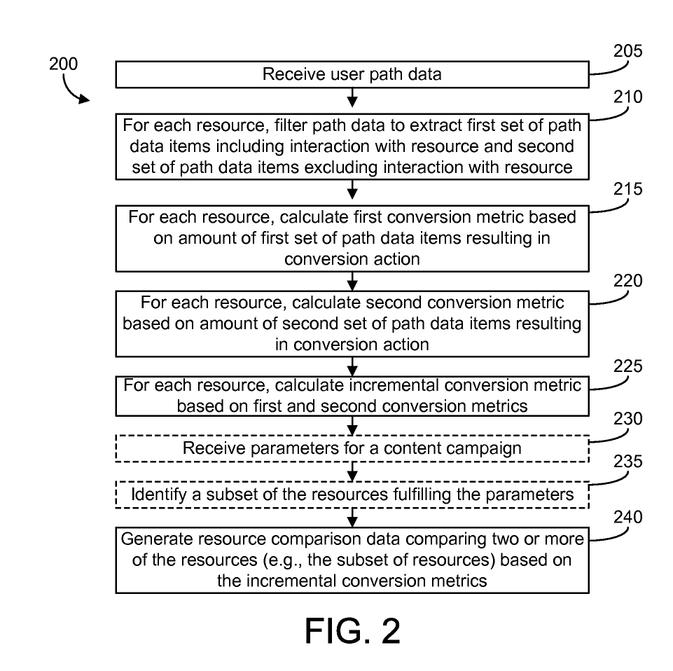

FIG. 2 illustrates a flow diagram of a process 200 for comparing resources based on incremental conversion metrics according to an illustrative implementation. Referring to both FIGS. 1 and 2, analysis system 150 may be configured to receive path data 162 including path data items representing paths 164 (205). Each path includes one or more previous interactions of a user with one or more resources (e.g., webpages, applications, etc.). In some implementations, some of the interactions may relate to content items provided within a resource (e.g., within a content interface). The content items may include paid content items (e.g., paid items displayed within a search engine results interface and/or a different webpage, such as through the use of an auction process) and/or unpaid content items (e.g., unpaid search results displayed within a search engine results interface, unpaid links within a webpage, etc.). The content campaign may include one or more content items that the content provider wishes to have presented to user devices 104 by content management system 108. In some implementations, some of the content items may have one or more products and/or services associated with the content item. In some implementations, such content items may be designed to promote one or more particular products and/or services. In some implementations, some content items may be configured to promote the content provider, an affiliate of the content provider, a resource (e.g., website) of the content provider, etc. in general, and the products and/or services associated with the content item may be any products and/or services offered for sale through the content provider, affiliate, resource, etc. In some implementations, some content items may be configured to direct user devices 104 to resources configured to request information from a user, such as a lead form provided on a webpage.

Path data 162 may include any type of data from which information about previous interactions of a user with resources and/or content presented therein can be determined. The interactions may be instances where impressions of a campaign content item have been displayed on the user device of the user, instances where the user clicked through or otherwise selected the content item, instances where the user converted (e.g., purchased a product/service as a direct or indirect result of an interaction with a campaign content item), etc.

In some implementations, path data 162 may include resource visitation data collected by analysis system 150 describing some or all activities leading to a website or other resource of the content provider. Analysis system 150 may collect information relating to a portion of the resource visited/accessed, an identifier associated with the user device that accessed the resource, information relating to an origin or previous location that the user/device last visited before accessing the resource, information relating to a trigger that caused the user device (e.g., device browser application) to navigate to the resource (e.g., the user manually accessing the resource, such as by typing a URL in an address bar, a link associated with a content item selected on the user device causing the user device to navigate to the resource, etc.), and/or other information relating to the user interaction with the resource. In some implementations, path data 162 may include one or more keywords associated with content items through which the resource was accessed.

In some implementations, path data 162 may include result data associated with a resource visit or other user interaction with one or more content items of the content campaign. The result data may indicate whether the visit resulted in the purchase of one or more products or services, an identity of any products/services purchased, a value of any purchased products/services, etc. In some implementations, path data 162 may be configured to follow a path from a first user visit to the resource and/or interaction with a content item of the content campaign to one or more conversions resulting from visits/interactions. The full path from a first user interaction to a converting action, such as a purchase or provision of information requested by a content provider, may be referred to as a converting path. In some implementations, path data 162 may include data relating to multiple conversion paths 164.

In various implementations, path data 162 may reflect one or more of a variety of different types of user interactions. In some illustrative implementations, the interactions may include viewing a content item impression, clicking on or otherwise selecting a content item impression, viewing a video, listening to an audio sample, viewing a webpage or other resource, and/or any other type of engagement with a resource and/or content item displayed thereon. In some implementations, the interactions may include any sort of user interaction with content without regard to whether the interaction results in a visit to a resource, such as a webpage, associated with the content provider.

In various implementations, a device identifier may be a browser cookie, a unique device identifier (e.g., a serial number), a device fingerprint (e.g., collection of non-private characteristics of the user device), or another type of identifier. The identifier may not include personally identifiable data from which an actual identity of the user can be discerned. Analysis system 150 may be configured to require consent from the user to tie an identifier to path data 162. In some implementations, path data from multiple sources may be utilized even if the path data sets reference different types of identifiers. For example, user paths may be joined by matching one identifier (e.g., browser cookie) with another identifier (e.g., a device identifier) to associate both path data sets as corresponding to a single user.

In some circumstances, path data 162 may include paths that appear to end prior to a conversion, but which are actually continued in other paths. In some implementations, analysis system 150 may be configured to determine whether any non-converting paths in path data 162 are actually continued in other user paths, and are not in fact non-converting paths. In some instances, some user paths may be incorrectly interpreted as non-converting paths ending in abandonment events. In some implementations, a user may complete one or more interactions on a first device, such as a mobile device, then move to a second device (e.g., a desktop or laptop computer) to complete additional interactions, the last of which may be a conversion action (e.g., a product purchase). In such implementations, path data 162 may not connect the interactions on the first device with those on the second device, and system 150 may improperly interpret the last interaction on the first device as an abandonment.

In some implementations, system 150 may be configured to detect false positive abandonment events within path data 162 and connect the related paths to form more accurate, complete conversion paths for use in analyzing negative interactions 168. System 150 may determine one or more false positive abandonment events within path data 162. In some implementations, system 150 may utilize an identifier or other signal associated with a path indicating that the user interactions associated with the path are continued on another path associated with another device. Based on the data, system 150 may determine whether a path that appears to be a non-converting path includes a false positive abandonment event, such that the user interactions were continued as reflected in another path associated with another device. System 150 may then merge the two partial paths to determine the full conversion path prior to analyzing negative interactions 168 based on the path.

For each of a set of resources to be analyzed, analysis system 150 may filter path data 162 to extract a first set of path data items including interactions with the resource and a second set of path data items that include paths excluding (i.e., not including) interactions with the resource (210). The first and second sets of paths may each include paths relating to multiple content providers. For instance, some of the paths in each of the sets may include interactions with content items submitted by a first content provider, some of the paths may include interactions with content items submitted by a second content provider, etc. In some implementations, path data 162 may include, for each path data item and/or each interaction, a resource field/item including identifiers of one or more resources associated with the interactions in the path. Analysis system 150 may search the resource fields/items and extract those paths including interactions with the resource as the first set of path data items. In some implementations, system 150 may extract those paths having resource fields/items not reflecting interactions with the resource to construct the second set of path data items. In other implementations, system 150 may include both the paths including interactions with the resource and the paths excluding interactions with the resource within the second set of path data items. In some implementations, system 150 may filter the paths to only include paths sharing a particular set of one or more common characteristics within the first and second sets of path data. For instance, system 150 may include only paths reflecting interactions with certain types of resources, paths including a certain number of one or more types of interactions (e.g., viewing impressions, clicks, etc.), paths involving interactions with certain types of content items (e.g., content categories, types/dimensions of content items, etc.), etc. Including only paths sharing common characteristics in the analysis may help reduce an impact of variables other than the resource on the conversion metrics.

For each of the resources, system 150 may calculate a first conversion metric based on an amount of the first set of path data items including interactions with the resource that result in a conversion action (215). In some implementations, the first conversion metric may be a conversion rate. The conversion rate may be based on a number of paths in the set resulting in conversion and either the number of paths not resulting in conversion or the total number of paths. In one implementation, the conversion rate may be defined as the number of paths resulting in conversion divided by the total number of paths, including paths that resulted in conversion and paths that do not result in conversion (e.g., expressed as a percentage). In another implementation, the conversion rate may be defined as the ratio of the number of paths resulting in conversion and the number of paths not resulting in conversion. In some implementations, the conversion metric may be a metric other than conversion rate, such as a number of converting paths and/or number of non-converting paths.

For each of the resources, system 150 may also generate a second conversion metric based on an amount of paths in the second set of paths that result in conversion (220). In some implementations, the second conversion metric may be a conversion rate. In some implementations, the second conversion metric may be based on an amount of total paths (e.g., including both the paths including and excluding the resource) resulting in conversion. In some implementations, the second conversion metric may be based on an amount of paths excluding the resource that result in conversion.

For each of the resources, system 150 may calculate an incremental conversion metric 176 based on the first and second conversion metrics (225). For instance, the incremental conversion metric for a resource may be defined as the ratio of the first conversion metric to the second conversion metric. The incremental conversion metric may relate to a contribution of the interactions with the resource in driving the conversions. The incremental conversion metric may be indicative of a contribution across paths relating to multiple content providers, as the underlying filtered paths upon which the first and second conversion metrics are calculated may relate to multiple content providers. In some implementations, the incremental conversion metric may be indicative of an absolute or relative amount of conversions that resulted from interaction with the resource as compared to not interacting with the resource. For instance, if the incremental conversion metric for a resource is high, system 150 may infer that the resource tends to successfully drive conversions more frequently than other resources may drive conversions. If the incremental conversion metric for a resource is low, system 150 may infer that the resource does not drive conversions as successfully as other resources may drive conversions. In some implementations, if the incremental conversion metric is particularly low (e.g., lower than a threshold), system 150 may infer that the interactions with the resource might be lowering the likelihood of conversion, as compared to if the user did not interact with the resource.

In some implementations, system 150 may calculate incrementality for each content provider on a given platform for each impression, segmented by conditions that could generate discrepancies in performance (e.g., creative, time lag, path position, frequency, content slot, etc.). In some implementations, each segmentation may be a highly granular, small sample. System 150 may combine the resulting output with paths across all content providers in the network, using the same variables so that they can be scored for each resource placement (e.g., calculate incrementality for all known display content providers on site X where a standard banner content item was shown to a user for the first time). This may result in a test-level incremental conversion metric for the content provider, and, when combined with all tests (e.g., tests for all content providers), a relative score for site X as a whole. In some implementations, the attribution paths of the content providers may be compared to ensure that they have comparable performance.

In some implementations, the first and/or second conversion metric and/or incremental conversion metric 176 for one or more of the resources may be generated based on a subset of the paths that include/do not include the resource, rather than all paths that include/do not include the resource. For instance, the first and/or second conversion metric and/or incremental conversion metric 176 for some resources may be generated based at least in part on one or more rules (e.g., based on mathematical models, experimental outcomes, etc.). This may help reduce the complexity of the process, as compared to calculating conversion metrics based on all paths, and may help reduce computing resources used to implement process 200.

In some implementations, system 150 may receive one or more parameters pertaining to a content campaign (230). The parameters may include, for instance, parameters relating to the timing of the campaign (e.g., dates on which the campaign is designated to run), one or more verticals or subject matter categories associated with the campaign, a size and/or shape of the content items (e.g., creatives) associated with the campaign, and/or other types of information. System 150 may compare these parameters with characteristics of the resources to identify a subset of resources fulfilling the parameters (235). For instance, system 150 may determine resources having available slots on the dates associated with the campaign, subject matter related to the verticals/categories associated with the campaign, content item slots that match the dimensions of the content items of the campaign, etc.

System 150 may generate resource comparison data 178 comparing two or more of the resources based on incremental conversion metrics 176 (240). In some implementations, resource comparison data 178 may provide a normalized metric indicating a relative performance of the campaign in relation to the other campaigns being analyzed (e.g., on a scale of one to ten, on a letter grade scale, etc.). In some implementations, resource comparison data 178 may additionally or alternatively include a ranking including one or more of the resources. For instance, resource comparison data 178 may include a full ranking, based on incremental conversion metrics 176, of all analyzed resources, or may include a list of the top-performing resources. In some implementations, resource comparison data 178 may be directed to all analyzed resources. In some implementations, resource comparison data 178 may be directed to only those resources fulfilling the parameters of a campaign for which recommendations are being provided.

In some implementations, system 150 may evaluate incrementality and generate resource comparison data 178 based in part on factors other than just the converting and/or non-converting paths of path data 162. For instance, in some implementations, mathematical models, experimental outcomes, and/or secondary research may be used in addition to analysis of path data 162 (e.g., to reduce complexity of the process). In one such implementation, if a test was run that determined that X interaction(s) were not incremental in most cases for a statistically-representative portion of the population, system 150 may be able to gain efficiency by applying this rule to the dataset rather than calculating conversion metrics based on every path. In some implementations, system 150 may apply such rules and utilize conversion metrics calculated from a portion of paths 164 to generate resource comparison data 178.

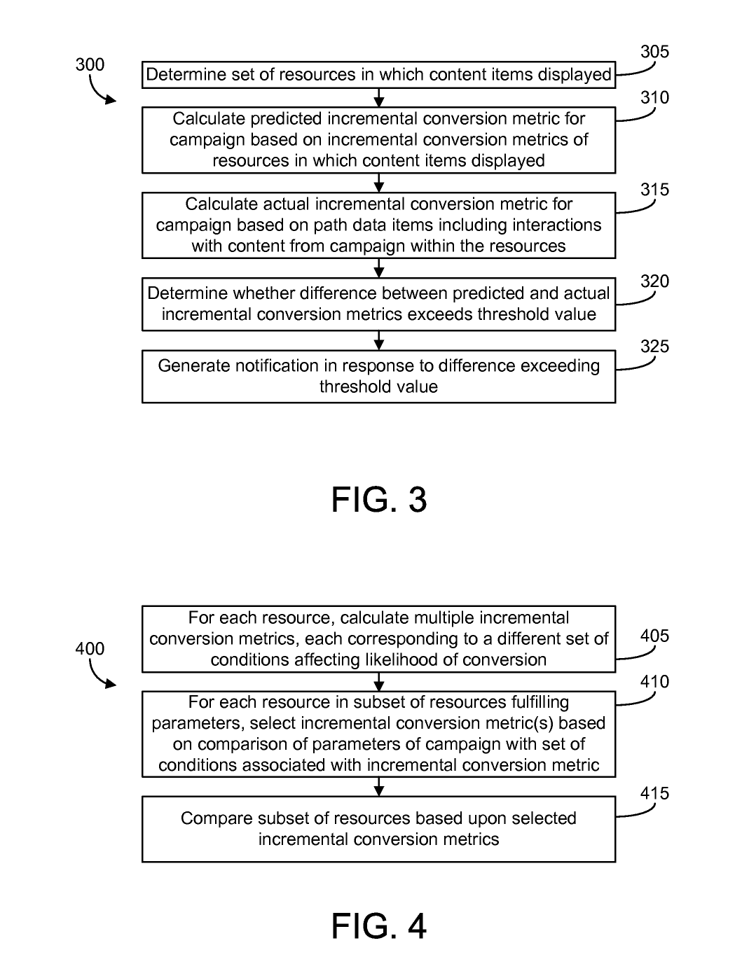

In some implementations, system 150 may be configured to assess the performance of a campaign after it has been implemented using incremental conversion metrics 176. FIG. 3 shows a flow diagram of a process 300 for assessing performance of a content campaign according to an illustrative implementation. System 150 may determine a set of resources in which content items from the content campaign have been and/or are to be displayed (305). In some implementations, system 150 may receive the list of resources based on a selection of resources received from a content provider and/or based on data received from content management system 108 regarding the campaign.

System 150 may calculate a predicted incremental conversion metric 180 for the campaign based on incremental conversion metrics 176 for the resources in which the content items are/will be displayed (310). In some implementations, predicted incremental conversion metric 180 may be a combination, such as an average or median, of the incremental conversion metrics for the resources in which the content items are/will be displayed. In some implementations, predicted incremental conversion metric 180 may be calculated based on a weighted combination (e.g., weighted average) of the incremental conversion metrics for the resources. For instance, predicted incremental conversion metric 180 for a resource may be a weighted average of the incremental conversion metrics for the resources, where the weighting is determined based on a frequency with which the content items from the campaign appeared in the resources.

System 150 may calculate an actual incremental conversion metric 182 for the campaign based on path data items including interactions with content from the campaign within the resources (315). In some implementations, system 150 may determine actual incremental conversion metric 182 in a manner similar to that discussed with respect to operation 225 of process 200. For instance, system 150 may calculate a first conversion metric (e.g., conversion rate) for a set of paths including interactions with the content campaign within the resources and a second conversion metric for a set of paths not including interactions with the content campaign within the resources. In some implementations, system 150 may filter the paths to only include paths sharing a particular set of one or more common characteristics when calculating actual incremental conversion metric 182.

System 150 may determine whether a difference between predicted incremental conversion metric 180 and actual incremental conversion metric 182 exceeds a threshold value (e.g., is higher than an upper threshold value and/or lower than a lower threshold value) (320). In some implementations, system 150 may subtract predicted incremental conversion metric 180 from actual incremental conversion metric 182, or vice-versa, to determine the difference. For instance, if system 150 subtracts predicted incremental conversion metric 180 from actual incremental conversion metric 182, and the difference is positive, it may be inferred that the campaign is performing well (e.g., better than the predicted value). If the difference is negative, it may be inferred that the campaign is not performing as well as expected (e.g., less than the predicted value). In other implementations, the difference may be calculated based on a ratio of predicted incremental conversion metric 180 and actual incremental conversion metric 182. For instance, the difference may be represented as a ratio of actual incremental conversion metric 182 to predicted incremental conversion metric 180. A difference value of greater than one may indicate better than predicted campaign performance, and a difference value of less than one may indicate lower than predicted campaign performance. In some implementations, multiple threshold values may be used. For instance, a high threshold and low threshold may be used, and a difference value above the high threshold may be classified as high performance, a difference value between the high and low thresholds may be classified as average performance, and a difference value below the low threshold may be classified as low performance. In various implementations, the threshold value may be a predefined value and/or may be configurable (e.g., by the content provider).

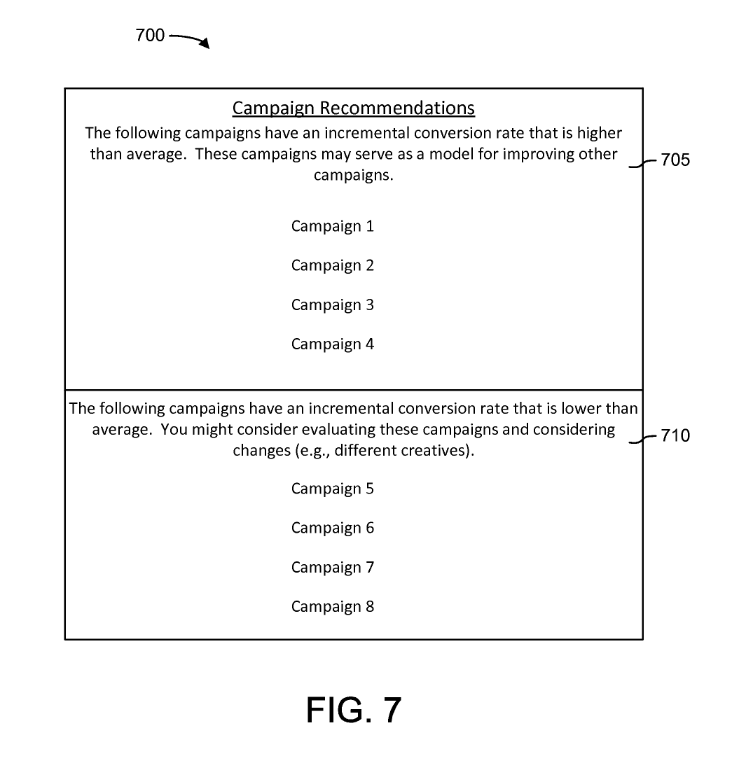

System 150 may generate one or more notifications in response to the difference exceeding (e.g., being higher or lower than) the threshold value (325). In some implementations, system 150 may generate an interface identifying high and/or low-performing campaigns, and/or providing recommendations for high-performing campaigns that might serve as a model for improving other campaigns, and/or low-performing campaigns that the content provider may wish to examine and, possibly, modify. For instance, if actual incremental conversion metric 182 is substantially lower than predicted incremental conversion metric 180 for a campaign, this could be an indication that users are not reacting well to the particular content items (e.g., creatives) of the campaign, as compared to other content displayed within the same resources, and the content provider may want to make some changes to the campaign content items and/or the parameters of the campaign. One illustrative interface that may be presented to a content provider is shown in FIG. 7, described below in greater detail. In other implementations, notifications may additionally or alternatively be provided through other methods, such as via email or another type of messaging system. In some implementations, system 150 may be configured to make recommendations (e.g., automated recommendations) based on the placements with the best score relative to price. In some implementations, system 150 may add or exclude networks having good or poor underlying performance.

In some implementations, system 150 may modify one or more bid parameters and/or budgets in response to the assessment. For instance, if actual incremental conversion metric 182 is lower than predicted incremental conversion metric 180 for a campaign, system 150 may lower a bid associated with one or more resources for the campaign and/or lower a budget associated with the campaign and/or resources. In some implementations, system 150 may cause the bid and/or budget to be lowered by transmitting a message to content management system 108 configured to cause content management system 108 to apply a bid multiplier or other bid modification to the bid parameters associated with the campaign. In some implementations, if actual incremental conversion metric 182 is higher than predicted incremental conversion metric 180 for a campaign, system 150 may lower a bid associated with one or more resources for the campaign and/or lower a budget associated with the campaign and/or resources. In some implementations, system 150 may monitor (e.g., periodically, continuously, upon occurrence of one or more conditions, etc.) a campaign and make modifications upon changing conditions. For instance, a content provider may invest $X in a resource where it performs well, but as that spend ramps up to $X+n, performance may decrease (e.g., due to the resource publisher running out of inventory and adding inventory in worse positions). In such an instance, system 150 may apply a bid modification reducing spend on the resource (e.g., back to the original level). In another instance, a content provider may spend $Y and find the campaign outperforming the benchmark predictions, and spend may be increased (e.g., until the actual performance lowers back to the original expectations/limits, at which point spend may be decreased).

In some implementations, system 150 may calculate multiple incremental conversion metrics 176 for each resource in an effort to minimize an impact of variables other than the resource and/or content from a content campaign on the calculated conversion metrics. FIG. 4 is a flow diagram of a process 400 for comparing resources using multiple incremental conversion metrics associated with different conditions according to an illustrative implementation. In some implementations, process 400 may be used in conjunction with providing comparisons between resources for particular content campaigns.

For each resource, system 150 may calculate multiple incremental conversion metrics 176 (405). Each incremental conversion metric 176 may correspond to a different set of conditions affecting a likelihood of conversion. Such conditions may include, but are not limited to, a number of interactions in the path, a type of interactions in the path (e.g., content item type, content interface type, type of user action, such as viewing and/or clicking on an impression, etc.), a number of interactions prior to and/or after predetermined types of interactions (e.g., interactions with a particular campaign), placement location within the resource (e.g., top item slot, above the fold within the resource, etc.), campaign type (e.g., display, search, etc.), and/or other types of conditions. In some implementations, different combinations of conditions may be identified using a machine learning process of system 150 configured to generate permutations of condition combinations based on a set or list of conditions. In some implementations, system 150 may be configured to remove or account for various combinations of the conditions in an effort to partially or fully isolate the impact, or quality, of the resource and/or content item impression itself, such that the resource and/or content item is one of the only, or the only, unaccounted variable.

For each resource in the subset of resources fulfilling the parameters, system 150 may select one or more incremental conversion metrics based on comparison of the parameters with the set of conditions associated with each incremental conversion metric (410). In some implementations, system 150 may select the incremental conversion metric(s) having conditions that most closely match the parameters of the campaign. For instance, in one implementation, if a campaign is a display network campaign with parameters indicating a preference that content items of the campaign are presented to each user a minimum of three times and a maximum of nine times within a week, system 150 may select the incremental conversion metric(s) corresponding to paths including interactions with display network campaign items, where particular items were displayed between three and nine times. Selecting incremental conversion metrics based on the parameters of the campaign may help provide a more pertinent comparison of the resources to the goals of the campaign. System 150 may then compare the subset of resources fulfilling the parameters based on the selected incremental conversion metrics for the resources (415). In some implementations, system 150 may combine (e.g., average) multiple incremental conversion metrics to generate the metrics for use in comparing the resources.

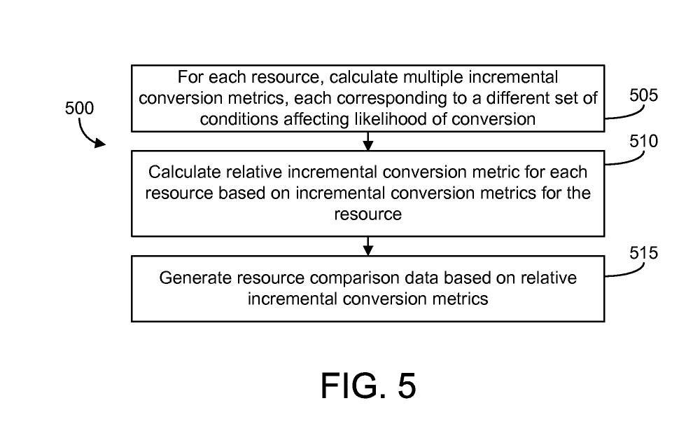

FIG. 5 is a flow diagram of another process 500 for comparing resources using multiple incremental conversion metrics associated with different conditions according to an illustrative implementation. Process 500 may be used to generate resource comparisons, and may or may not be used in conjunction with generating comparisons specific to particular campaigns.

For each resource, system 150 may calculate multiple incremental conversion metrics 176 (505). Each incremental conversion metric 176 may correspond to a different set of conditions affecting a likelihood of conversion.

System 150 may calculate a relative incremental conversion metric 186 for each resource based on the individual incremental conversion metrics (510). In some implementations, relative incremental conversion metric 186 may be a combination (e.g., average, median, etc.) of the individual incremental conversion metrics. In some implementations, system 150 may be configured to identify and remove, or reduce an impact of, outlying metrics that may be different from normal due to the conditions associated with the metrics. For instance, system 150 may remove a predetermined number of the highest and/or lowest metrics when calculating relative incremental conversion metric 186 for the resource. In another illustrative implementation, system 150 may apply weights to the values to weigh outlying values less heavily than more consistent values. In some implementations, relative incremental conversion metric 186 may provide a better indication of the impact of the resource on the likelihood of conversion by reducing the impact of the other conditions that affect the likelihood of conversion. System 150 may generate resource comparison data 178 based on relative incremental conversion metric 186 (515).

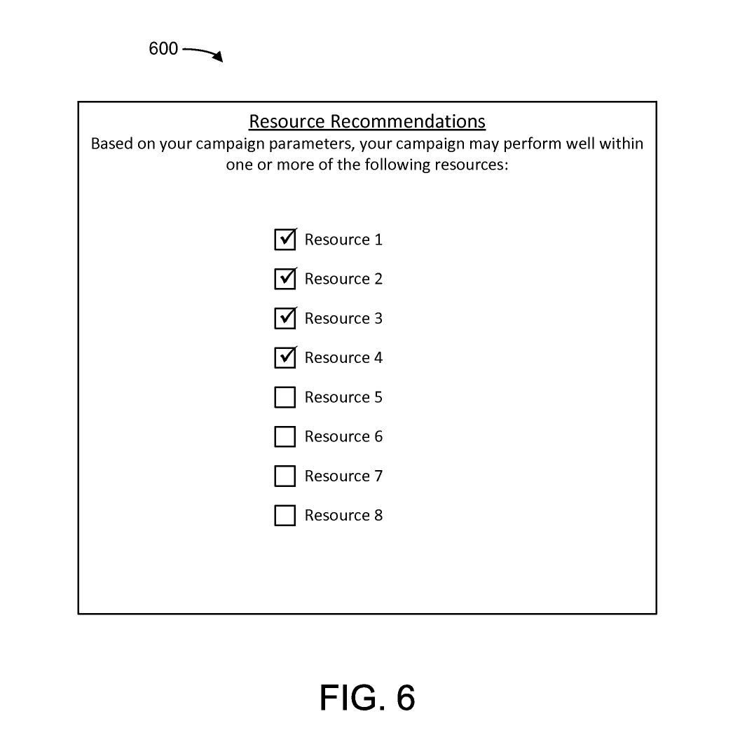

FIG. 6 is an illustration of a user interface 600 configured to provide resource recommendations according to an illustrative implementation. In the illustrated implementation, interface 600 includes a list of resources (e.g., websites) that are predicted to perform well based on the parameters of a content campaign. In some implementations, interface 600 may include resources having an incremental conversion metric above a certain threshold value, and/or may include a predetermined number of resources having a highest/best incremental conversion metric. Interface 600 also includes checkbox inputs next to each resource that may be used to receive input from the content provider indicating whether or not the content provider wishes to include the resource as part of its campaign.

FIG. 7 is an illustration of a user interface 700 configured to provide an assessment of one or more content campaigns according to an illustrative implementation. A first portion 705 provides a list of campaigns that have performed well compared to a predicted performance, and that may serve as good examples for organizing other campaigns. In some implementations, the campaigns in portion 705 may be campaigns with actual incremental conversion metrics that are higher than predicted incremental conversion metrics by greater than a threshold value. A second portion 710 provides a list of campaigns that have underperformed expectations, and that the content provider may wish to review for potential modifications (e.g., changes to the content items of the campaign). In some implementations, the campaigns in portion 710 may be campaigns with actual incremental conversion metrics that are lower than predicted incremental conversion metrics by more than a threshold value. In some implementations, the threshold values may be used to help the content provider focus on campaigns that are overperforming or underperforming by a substantial amount, such that the efforts of the content provider may yield a greatest return on investment, as opposed to those campaigns that are slightly underperforming the predicted value but are close to the predicted value.

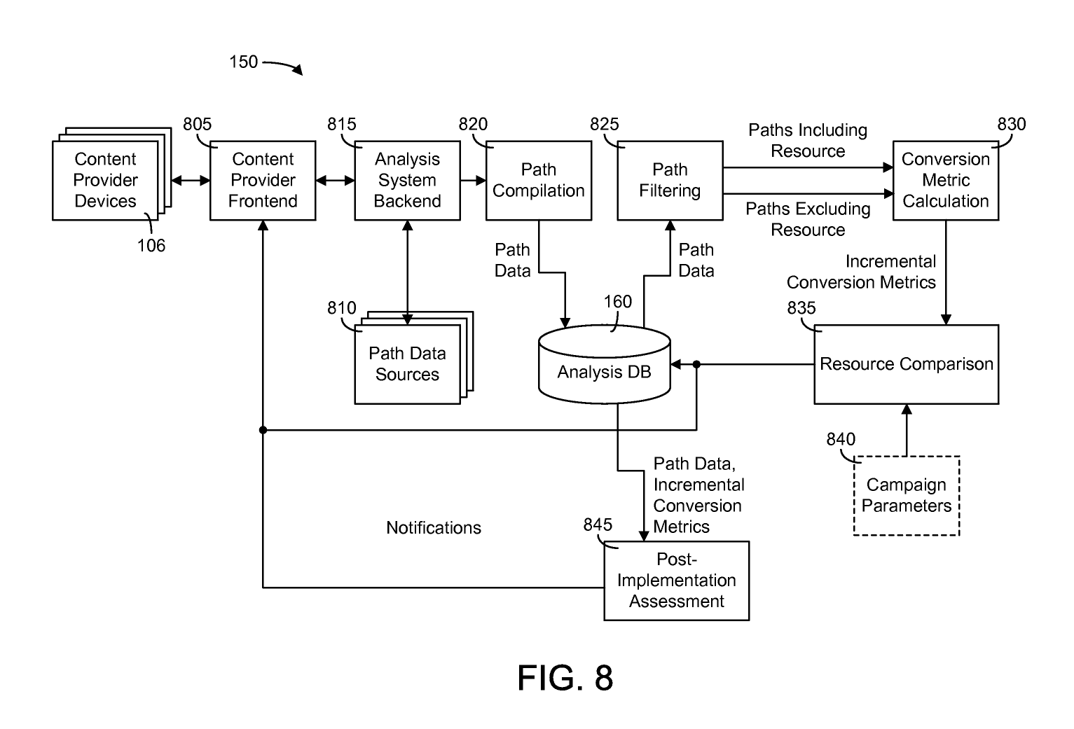

Referring now to FIG. 8, one detailed illustrative implementation of analysis system 150 is provided. In the illustrated implementation, system 150 includes a content provider frontend 805, an analysis system backend 815, a path compilation module 820, a path filtering module 825, a conversion metric calculation module 830, and a resource comparison module 835. In some implementations, system 150 may include a post-implementation assessment module 845. It should be understood that the detailed implementation of analysis system 150 shown in FIG. 8 is provided for purposes of illustration, and in other implementations, analysis system 150 may include additional, fewer, and/or different components. Further, each of the illustrated systems and/or components may be implemented as a separate computing system, multiple systems may be combined within a single hardware system, and/or one or more systems or components may be implemented in a cloud, or distributed computing, environment.

Content provider devices 106 may provide information to and/or receive information from analysis system 150 via a content provider frontend 805. Content provider frontend 805 may provide an interface through which content providers can provide data, modify settings or parameters used by analysis system 150, receive information from analysis system 150, etc. In some implementations, content provider frontend 805 may be or include a web-based user interface (e.g., implemented via a web-based programming language such as HTML, Javascript, etc.). In some implementations, content provider frontend 805 may include a custom API specific to a particular content provider. In some implementations, content provider frontend 805 may allow content providers to upload data sets individually and/or in batches.

Content provider frontend 805 may transmit data to and receive data from an analysis system backend 815. Analysis system backend 815 may be configured to retrieve data and/or generate commands needed to perform various functions of analysis system 150. In some implementations, analysis system backend 815 may implement the various functions by transmitting commands to various modules configured to carry out particular functions or sets of functions.

Analysis system backend 815 may collect data relating to user interactions with resources from one or more path data sources 810. Path data sources 810 may be any type of data sources that provide information pertaining to interactions of users with resources and/or content items presented therein. In some implementations, path data sources 810 may be received from content management system 108 (e.g., data regarding interactions of user devices 104 with one or more content items served by content management system 108), a search engine server (e.g., data regarding interactions of user devices 104 with search engine results, queries submitted by user devices 104, links clicked through by user devices 104, etc.), servers providing one or more online services (e.g., location-based services, such as a mapping service, media services, such as an online video and/or photo service, social media services, such as an online social network, etc.), and/or other types of sources. In some implementations, analysis system backend 815 may transmit request messages to path data sources 810 for interaction data, and, in response, path data sources 810 may transmit messages to analysis system backend 815 including the interaction data. In some implementations, the response messages may include one or more identifiers (e.g., device identifiers) that may be used to identify a user device 104 associated with the interaction data and/or one or more pieces of timestamp data used to identify when the interactions occurred.

Analysis system backend 815 may transmit the interaction data to a path compilation module 820. Path compilation module 820 may construct path data 162 including paths 164 based on the interaction data. In some implementations, the interaction data may include disparate interaction data that is not correlated when received by analysis system backend 815, and path compilation module 820 may utilize the identifiers associated with the interaction data to identify which interactions are associated with each user device 104. Path compilation module 820 may utilize the timestamp data and identifiers to build paths 164 for the different user devices 104. The resultant path data 162 may be stored in analysis database 160.

Path filtering module 825 may be configured to retrieve path data 162 from analysis database 160 and, for each of one or more resources, filter the path data into a first set of path data items relating to the resource and a second set of path data items including paths not relating to the resource (see, e.g., operation 210 of process 200). Path filtering module 825 may output data reflecting the two sets of paths. In some implementations, path filtering module 825 may output the actual path data. In other implementations, path filtering module 825 may provide identifiers to the path data stored in another data storage area (e.g., analysis database 160).

Conversion metric calculation module 830 may calculate conversion metrics 172 for each of the sets of path data for each resource (see, e.g., operations 215 and 220 of process 200). Conversion metric calculation module 830 may also calculate one or more of incremental conversion metrics 176 (see, e.g., operation 225 of process 200, operation 405 of process 400, and/or operation 505 of process 500), predicted incremental conversion metric 180 (see, e.g., operation 310 of process 300), actual incremental conversion metric 182 (see, e.g., operation 315 of process 300), and/or relative incremental conversion metric 186 (see, e.g., operation 510 of process 500). In some implementations, conversion metric calculation module 830 may calculate one or more of these values based in part on campaign parameters 840.

Resource comparison module 835 is configured to generate resource comparison data 178 based on metrics 176 and/or 186 (see, e.g., operation 240 of process 200, operation 415 of process 400, and/or operation 515 of process 500). In some implementations, resource comparison module 835 may generate resource comparison data 178 for specific resources identified based on campaign parameters 840 for a content campaign. Resource comparison data 178 may be stored in analysis database 160 and/or provided to content provider frontend 805 for presentation to a content provider device 106 via an interface generated by content provider frontend 805.

In some implementations, system 150 may include a post-implementation assessment module 845 configured to assess the performance of a campaign after implementation based on incremental conversion metrics and provide notifications/recommendations regarding the campaign (see, e.g., process 300). In some implementations, post-implementation assessment module 845 may calculate one or more of the metrics using conversion metric calculation module 830. Notifications/recommendations generated by post-implementation assessment module 845 may be provided to content provider frontend 805 for presentation to a content provider device 106.

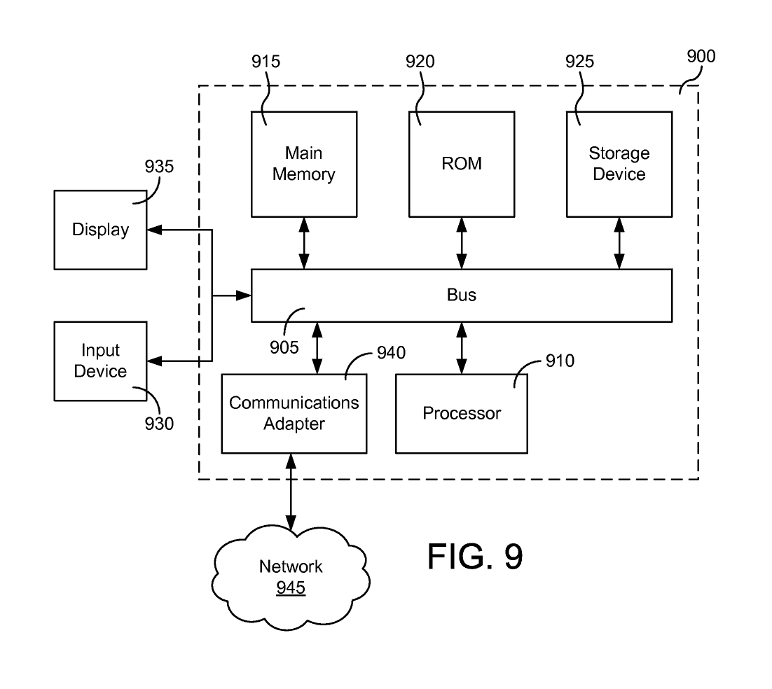

FIG. 9 illustrates a depiction of a computer system 900 that can be used, for example, to implement an illustrative user device 104, an illustrative content management system 108, an illustrative content provider device 106, an illustrative analysis system 150, and/or various other illustrative systems described in the present disclosure. The computing system 900 includes a bus 905 or other communication component for communicating information and a processor 910 coupled to the bus 905 for processing information. The computing system 900 also includes main memory 915, such as a random access memory (RAM) or other dynamic storage device, coupled to the bus 905 for storing information, and instructions to be executed by the processor 910. Main memory 915 can also be used for storing position information, temporary variables, or other intermediate information during execution of instructions by the processor 910. The computing system 900 may further include a read only memory (ROM) 910 or other static storage device coupled to the bus 905 for storing static information and instructions for the processor 910. A storage device 925, such as a solid state device, magnetic disk or optical disk, is coupled to the bus 905 for persistently storing information and instructions.

The computing system 900 may be coupled via the bus 905 to a display 935, such as a liquid crystal display, or active matrix display, for displaying information to a user. An input device 930, such as a keyboard including alphanumeric and other keys, may be coupled to the bus 905 for communicating information, and command selections to the processor 910. In another implementation, the input device 930 has a touch screen display 935. The input device 930 can include a cursor control, such as a mouse, a trackball, or cursor direction keys, for communicating direction information and command selections to the processor 910 and for controlling cursor movement on the display 935.

In some implementations, the computing system 900 may include a communications adapter 940, such as a networking adapter. Communications adapter 940 may be coupled to bus 905 and may be configured to enable communications with a computing or communications network 945 and/or other computing systems. In various illustrative implementations, any type of networking configuration may be achieved using communications adapter 940, such as wired (e.g., via Ethernet), wireless (e.g., via WiFi, Bluetooth, etc.), pre-configured, ad-hoc, LAN, WAN, etc.

According to various implementations, the processes that effectuate illustrative implementations that are described herein can be achieved by the computing system 900 in response to the processor 910 executing an arrangement of instructions contained in main memory 915. Such instructions can be read into main memory 915 from another computer-readable medium, such as the storage device 925. Execution of the arrangement of instructions contained in main memory 915 causes the computing system 900 to perform the illustrative processes described herein. One or more processors in a multi-processing arrangement may also be employed to execute the instructions contained in main memory 915. In alternative implementations, hard-wired circuitry may be used in place of or in combination with software instructions to implement illustrative implementations. Thus, implementations are not limited to any specific combination of hardware circuitry and software.

Although an example processing system has been described in FIG. 9, implementations of the subject matter and the functional operations described in this specification can be carried out using other types of digital electronic circuitry, or in computer software, firmware, or hardware, including the structures disclosed in this specification and their structural equivalents, or in combinations of one or more of them.

Implementations of the subject matter and the operations described in this specification can be carried out using digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example, a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be carried out using a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be carried out using a computing system that includes a back-end component, e.g., a data server, or that includes a middleware component, e.g., an application server, or that includes a front-end component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In some illustrative implementations, the features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be carried out in combination or in a single implementation. Conversely, various features that are described in the context of a single implementation can also be carried out in multiple implementations, separately, or in any suitable subcombination. Moreover, although features may be described above as acting in certain combinations and even initially claimed as such, one or more features from a claimed combination can, in some cases, be excised from the combination, and the claimed combination may be directed to a subcombination or variation of a subcombination. Additionally, features described with respect to particular headings may be utilized with respect to and/or in combination with illustrative implementations described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving, by one or more processors, path data comprising a plurality of path data items representing a plurality of paths, each path comprising one or more interactions of a user with content items published within one or more of a plurality of resources;
for each resource of a first set of the plurality of resources:
filtering, by the one or more processors, the path data to extract a first set of path data items including an interaction with the resource and a second set of path data items, the second set of path data including paths that exclude an interaction with the resource;
calculating, by the one or more processors, a first conversion metric based on an amount of the first set of path data items including the interaction with the resource resulting in one of a plurality of conversion actions reflected in the path data;
calculating, by the one or more processors, a second conversion metric based on an amount of the second set of path data items resulting in one of the conversion actions; and
calculating, by the one or more processors, an incremental conversion metric for the resource based on the first conversion metric and the second conversion metric, the incremental conversion metric relating to a contribution of the interactions with the resource in causing the conversion actions; and
generating resource comparison data comparing two or more of the first set of resources based on the incremental conversion metrics for the two or more resources.

2. The method of claim 1, further comprising:
receiving one or more parameters for a content campaign; and
identifying a subset of the first set of resources fulfilling the parameters;
wherein the step of generating the resource comparison data comprises generating the resource comparison data to compare the subset of resources based on the incremental conversion metrics for the subset of resources.

3. The method of claim 2, further comprising:
determining a second set of the plurality of resources in which content items from the content campaign are displayed;
calculating a predicted incremental conversion metric for the content campaign based on the incremental conversion metrics for the second set of resources;
calculating an actual incremental conversion metric for the content campaign based on a third set of path data items including an interaction with content items from the content campaign within the second set of resources;
determining whether a difference between the predicted incremental conversion metric and the actual incremental conversion metric exceeds a threshold value; and
generating a notification in response to the difference exceeding the threshold value.

4. The method of claim 3, wherein executing the action comprises generating a notification in response to the difference exceeding the threshold value.

5. The method of claim 3, wherein executing the action comprises modifying a bid associated with the content campaign in response to the difference exceeding the threshold value.

6. The method of claim 3, wherein determining whether the difference exceeds the threshold value comprises determining the actual incremental conversion metric is lower than the predicted incremental conversion metric by greater than the threshold value, and wherein the notification comprises a recommendation to modify one or more content items of the content campaign.

7. The method of claim 2, the step of calculating the incremental conversion metric comprising calculating a plurality of incremental conversion metrics for each resource of the first set of resources, each of the plurality of incremental conversion metrics corresponding to a different set of conditions affecting a likelihood of conversion, and the step of generating the resource comparison data comprising:
selecting, for each resource of the subset of resources, one or more of the incremental conversion metrics for the resource based on comparison of the parameters with the set of conditions associated with the incremental conversion metrics; and
comparing the subset of resources based upon the selected incremental conversion metrics for the subset of resources.

8. The method of claim 1, the step of filtering comprising selecting path data items sharing a plurality of similar characteristics for the first set and second set of path data items.

9. The method of claim 1, wherein:
the step of calculating the incremental conversion metric comprises calculating a plurality of incremental conversion metrics for each resource of the first set of resources, each of the plurality of incremental conversion metrics corresponding to a different set of conditions affecting a likelihood of conversion;
the method further comprises calculating a relative incremental conversion metric for each resource based on the incremental conversion metrics for the resource; and
the step of generating the resource comparison data is based on the relative incremental conversion metrics for the two or more resources.

10. The method of claim 1, wherein the first conversion metric and the second conversion metric comprise a conversion rate, wherein the conversion rate is based on a number of paths resulting in one of the conversion actions and one of:
a number of paths not resulting in one of the conversion actions; or
a total number of the paths resulting in one of the conversion actions and the paths not resulting in one of the conversion actions.

11. The method of claim 1, the step of calculating the incremental conversion metric for each of the resources comprising calculating the incremental conversion metric for one or more of the resources based at least in part on a rule associated with one or more interaction types.

12. A system comprising:
at least one computing device operably coupled to at least one memory and configured to:
receive path data comprising a plurality of path data items representing a plurality of paths, each path comprising one or more interactions of a user with content items published within one or more of a plurality of resources;
for each resource of a first set of the plurality of resources:
filter the path data to extract a first set of path data items including an interaction with the resource and a second set of path data items, the second set of path data including paths that exclude an interaction with the resource;
calculate a first conversion metric based on an amount of the first set of path data items including the interaction with the resource resulting in one of a plurality of conversion actions reflected in the path data;
calculate a second conversion metric based on an amount of the second set of path data items resulting in one of the conversion actions; and
calculate an incremental conversion metric for the resource based on the first conversion metric and the second conversion metric, the incremental conversion metric relating to a contribution of the interactions with the resource in causing the conversion actions; and
generate resource comparison data comparing two or more of the first set of resources based on the incremental conversion metrics for the two or more resources.

13. The system of claim 12, wherein the at least one computing device is further configured to:
receive one or more parameters for a content campaign; and
identify a subset of the first set of resources fulfilling the parameters;
wherein the step of generating the resource comparison data comprises generating the resource comparison data to compare the subset of resources based on the incremental conversion metrics for the subset of resources.

14. The system of claim 13, wherein the at least one computing device is further configured to:
determine a second set of the plurality of resources in which content items from the content campaign are displayed;
calculate a predicted incremental conversion metric for the content campaign based on the incremental conversion metrics for the second set of resources;
calculate an actual incremental conversion metric for the content campaign based on a third set of path data items including an interaction with content items from the content campaign within the second set of resources;
determine whether a difference between the predicted incremental conversion metric and the actual incremental conversion metric exceeds a threshold value; and
generate a notification in response to the difference exceeding the threshold value.

15. The system of claim 14, wherein the at least one computing device is configured to determine the actual incremental conversion metric is lower than the predicted incremental conversion metric by greater than the threshold value, and wherein the notification comprises a recommendation to modify one or more content items of the content campaign.

16. The system of claim 13, wherein the at least one computing device is configured to calculate a plurality of incremental conversion metrics for each resource of the first set of resources, each of the plurality of incremental conversion metrics corresponding to a different set of conditions affecting a likelihood of conversion, and wherein the at least one computing device is configured to generate the resource comparison data by:
selecting, for each resource of the subset of resources, one or more of the incremental conversion metrics for the resource based on comparison of the parameters with the set of conditions associated with the incremental conversion metrics; and
comparing the subset of resources based upon the selected incremental conversion metrics for the subset of resources.

17. The system of claim 12, wherein the at least one computing device is configured to select path data items sharing a plurality of similar characteristics for the first set and second set of path data items.

18. The system of claim 12, wherein the at least one computing device is configured to:
calculate a plurality of incremental conversion metrics for each resource of the first set of resources, each of the plurality of incremental conversion metrics corresponding to a different set of conditions affecting a likelihood of conversion;
calculate a relative incremental conversion metric for each resource based on the incremental conversion metrics for the resource; and
generate the resource comparison data based on the relative incremental conversion metrics for the two or more resources.

19. One or more computer-readable storage media having instructions stored thereon that, when executed by at least one processor, cause the at least one processor to perform operations comprising:
receiving path data comprising a plurality of path data items representing a plurality of paths, each path comprising one or more interactions of a user with content items published within one or more of a plurality of resources;
for each resource of a first set of the plurality of resources:
filtering the path data to extract a first set of path data items including an interaction with the resource and a second set of path data items, the second set of path data including paths that exclude an interaction with the resource;
calculating a first conversion metric based on an amount of the first set of path data items including the interaction with the resource resulting in one of a plurality of conversion actions reflected in the path data;
calculating a second conversion metric based on an amount of the second set of path data items resulting in one of the conversion actions; and
calculating an incremental conversion metric for the resource based on the first conversion metric and the second conversion metric, the incremental conversion metric relating to a contribution of the interactions with the resource in causing the conversion actions;
receiving one or more parameters for a content campaign;
identifying a subset of the first set of resources fulfilling the parameters; and
generating resource comparison data comparing the subset of resources based on the incremental conversion metrics for the subset of resources.

20. The one or more computer-readable storage media of claim 19, the operations further comprising:
determining a second set of the plurality of resources in which content items from the content campaign are displayed;
calculating a predicted incremental conversion metric for the content campaign based on the incremental conversion metrics for the second set of resources;
calculating an actual incremental conversion metric for the content campaign based on a third set of path data items including an interaction with content items from the content campaign within the second set of resources;
determining whether a difference between the predicted incremental conversion metric and the actual incremental conversion metric exceeds a threshold value; and
generating a notification in response to the difference exceeding the threshold value.
